(19) United States
(12) Patent Application Publication
(10) Pub. No.: US 2007/0110433 A1
(43) Pub. Date: May 17, 2007

(54) Shutter driving apparatus for camera module

(75) Inventor: Tsumori Masahiko, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/375,770

(22) Filed: Mar. 15, 2006

(30) Foreign Application Priority Data
Nov. 17, 2005 (KR) 2005-110052

(51) Int. Cl. G03B 9/08

(52) U.S. Cl. 396/469

(57) ABSTRACT

A shutter driving apparatus for a camera module has a shutter driving section constructed to slidingly move shutter blades provided to a camera lens module in both sideward directions to thereby open and close a lens opening. The shutter driving apparatus comprises a lens housing; a pair of shutter blades provided to the lens housing to be slidingly moved in a lengthwise direction of the lens housing to thereby open and close a lens opening of the camera lens module; and a pair of shutter driving sections respectively connected to the shutter blades via rotation links and each being configured for creating a pair of electromagnetically-opposite electromagnet poles and having a permanent magnet positioned between the poles such that a permanent magnet with at least one of the poles and connected to the rotation link is rotated due to a magnetic field created as current is applied to the electromagnet, to slidingly move an associated shutter blade.

### CLAIM FOR PRIORITY

This application claims priority to an application entitled “Shutter driving apparatus for camera module” filed in the Korean Intellectual Property Office on Nov. 17, 2005 and assigned Serial No. 2005-110052, the contents of which are hereby incorporated by reference.

### BACKGROUND

1. Field of the Invention

The present invention relates to a construction for sliding shutter blades, and more particularly, to a shutter driving apparatus for a camera module, which slidingly moves shutter blades provided to a camera lens module in both sideward directions so as to open and close a lens opening.

2. Description of the Related Art

As is generally known in the art, a camera module is used in a video camera, an electronic still camera, a PC camera terminal, a camera phone, and so on, to recognize an image.

These days, as the sizes of a camera module and a photographed image shrink with the development of high precision technologies, various camera modules have been disclosed in the art, which are miniaturized so that a user can photograph an object while holding each camera module in the hand and without the aid of a tripod, etc.

In this regard, recently, by mounting a camera module to a portable terminal, it becomes possible to implement visual conversation with a counterpart or take a still image or a moving picture of an object which is desired to be photographed.

Therefore, a portable terminal which serves as a medium for transmitting voices and letters has been changed to a high performance complex instrument equipped with a camera module capable of momentarily capturing, storing and transmitting a current image.

In a camera module, the iris of a camera lens and a shutter blade are usually installed to be overlapped with each other.

Describing a construction of a conventional camera module 1 with reference to FIGS. 1 and 2, the camera module 1 comprises a lens housing 2, a circuit board (not shown) arranged in the lens housing 2, a camera lens module 3 provided to the circuit board, a shutter blade 5 installed over the lens of the camera lens module 3 to be rotated about an axis ‘A1’ in forward and backward directions to thereby open and close a lens opening 4, and a shutter driving section 6 installed on one end of the shutter blade 5 and provided with an electromagnet (not shown) to create a magnetic field and rotate the shutter blade 5 as currents are applied to the electromagnet.

The lens housing 2 has the shutter driving section 6 and the shutter blade 5 and defines a space in which the shutter blade 5 can be rotated.

However, a drawback of the conventional shutter driving apparatus for the camera module, constructed as described above, is that, since the camera module 1 must define the space in which the shutter blade 5 can be rotated to open and close the lens opening 4. This constitutes a limitation in decreasing the size and volume of the camera module 1. Miniaturization and slimness of the camera module is concomitantly limited.

### SUMMARY OF THE INVENTION

The present invention has been made to solve the above-mentioned problems occurring in the prior art, and the present invention, in one aspect, provides a shutter driving apparatus for a camera module, in which a pair of shutter driving sections are constructed to slidingly move shutter blades provided to a camera lens module in both sideward directions to thereby open and close a lens opening. The space required to install the shutter driving apparatus in the camera lens module can, as a result, be reduced, and miniaturization and slimness of the camera module can be ensured.

In another aspect, the present invention provides a shutter driving apparatus for a camera module, in which a pair of shutter driving sections are constructed to slidingly move shutter blades provided to a camera lens module, using wires in both sideward directions to thereby open and close a lens opening. Opening and closing operations of the shutter blades is easily implemented according to this design.

A first embodiment of the present invention, according to the first above-described aspect, comprises a shutter driving apparatus for a camera lens module that includes a lens housing; a pair of shutter blades provided to the lens housing to be slidingly moved in a lengthwise direction of the lens housing to thereby open and close a lens opening of the camera lens module; and a pair of shutter driving sections respectively connected to the shutter blades via rotation links, the sections each having an electromagnet and a permanent magnet positioned between the poles of the electromagnet such that the permanent magnet is rotated due to a magnetic field created as current is applied to the electromagnet, to slidingly move an associated shutter blade.

A second embodiment of the present invention directed to achieving the second above-described aspect comprises a shutter driving apparatus, for a camera lens module, that includes a lens housing; first and second shutter blades provided to the lens housing to be slidingly moved in a lengthwise direction of the lens housing to thereby open and close a lens opening of the camera lens module; a shutter driving section connected to the first shutter blade via a rotation link and having an electromagnet and a permanent magnet connected to the rotation link and positioned between the poles of the electromagnet such that the permanent magnet is rotated due to a magnetic field created as current is applied to the electromagnet, to slidingly move the shutter blades; and at least one wire winding means for winding and unwinding wires which respectively connect the first and second shutter blades to the shutter driving section, when the shutter driving section is operated, and for thereby slidingly moving the shutter blades.

### BRIEF DESCRIPTION OF THE DRAWINGS

The above features and advantages of the present invention will be more apparent from the following detailed description when taken in conjunction with the accompanying drawings, in which:

FIG. 1 is a perspective view illustrating a conventional shutter driving apparatus for a camera module;

FIG. 2 is a plan view illustrating an operating state of the conventional shutter driving apparatus for a camera module;

FIG. 3 is an exploded perspective view illustrating a construction of a shutter driving apparatus for a camera module in accordance with a first embodiment of the present invention;

FIG. 4 is an exploded perspective view illustrating the assembled state of shutter blades in the construction of the shutter driving apparatus for a camera module in accordance with the first embodiment of the present invention;

FIG. 5 is a perspective view illustrating the assembled state of the shutter driving apparatus for a camera module in accordance with the first embodiment of the present invention;

FIG. 6 is a plan view illustrating a state before the shutter driving apparatus for a camera module in accordance with the first embodiment of the present invention is operated;

FIG. 7 is a perspective view illustrating an operation pattern of the shutter driving apparatus for a camera module in accordance with the first embodiment of the present invention;

FIG. 8 is a plan view illustrating the operation pattern of the shutter driving apparatus for a camera module in accordance with the first embodiment of the present invention;

FIG. 9 is a perspective view illustrating a state after the shutter driving apparatus for a camera module in accordance with the first embodiment of the present invention is operated;

FIG. 10 is a plan view illustrating the state after the shutter driving apparatus for a camera module in accordance with the first embodiment of the present invention is operated;

FIG. 11 is a perspective view illustrating a variation of the shutter blades in the construction of the shutter driving apparatus for a camera module in accordance with the first embodiment of the present invention;

FIG. 12 is an exploded perspective view illustrating a construction of a shutter driving apparatus for a camera module in accordance with a second embodiment of the present invention;

FIG. 13 is a partially cut-away perspective view illustrating the assembled state of shutter blades in the construction of the shutter driving apparatus for a camera module in accordance with the second embodiment of the present invention;

FIG. 14 is a perspective view illustrating the assembled state of the shutter driving apparatus for a camera module in accordance with the second embodiment of the present invention;

FIG. 15 is a plan view illustrating a state before the shutter driving apparatus for a camera module in accordance with the second embodiment of the present invention is operated;

FIG. 16 is a perspective view illustrating an operation pattern of the shutter driving apparatus for a camera module in accordance with the second embodiment of the present invention;

FIG. 17 is a plan view illustrating the operation pattern of the shutter driving apparatus for a camera module in accordance with the second embodiment of the present invention;

FIG. 18 is a perspective view illustrating a state after the shutter driving apparatus for a camera module in accordance with the second embodiment of the present invention is operated; and

FIG. 19 is a plan view illustrating the state after the shutter driving apparatus for a camera module in accordance with the second embodiment of the present invention is operated.

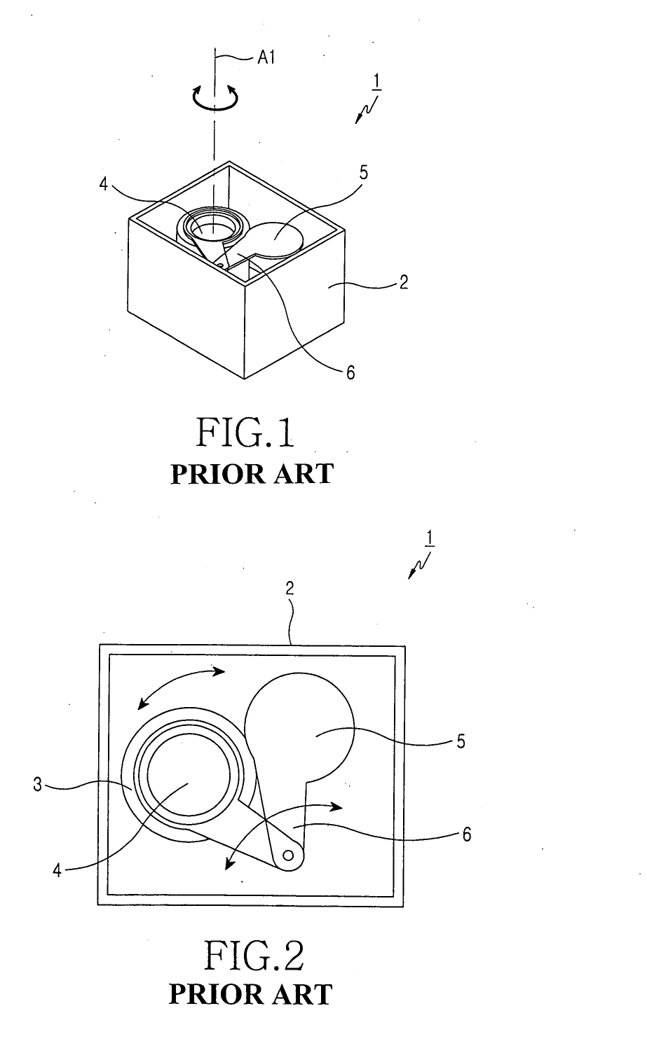

### DETAILED DESCRIPTION

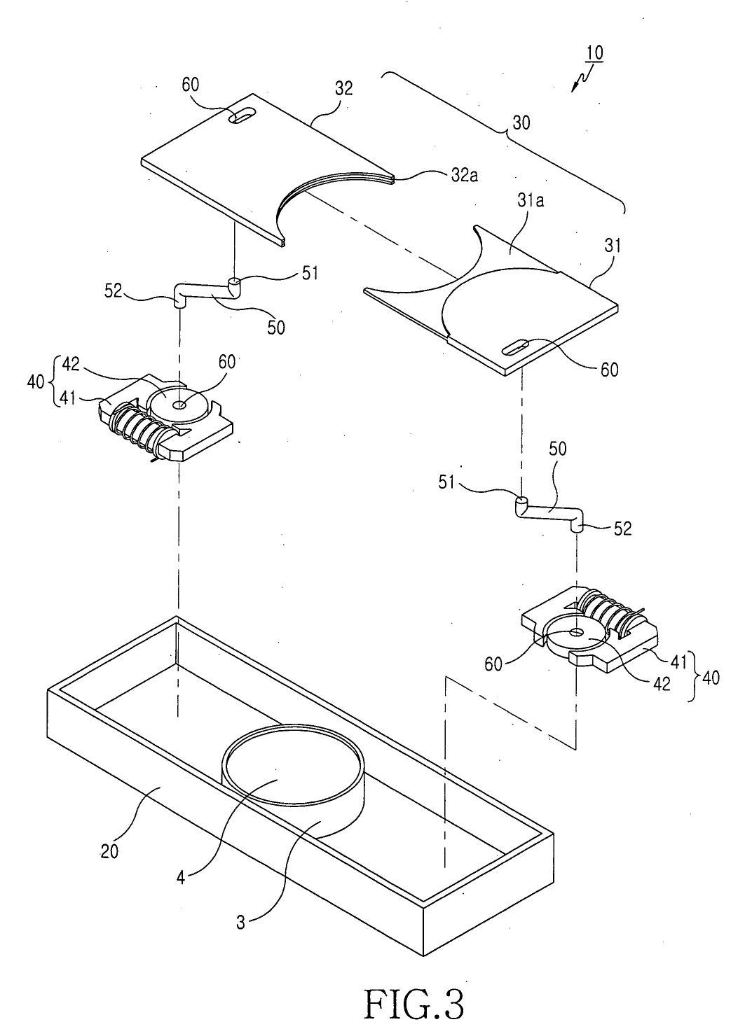

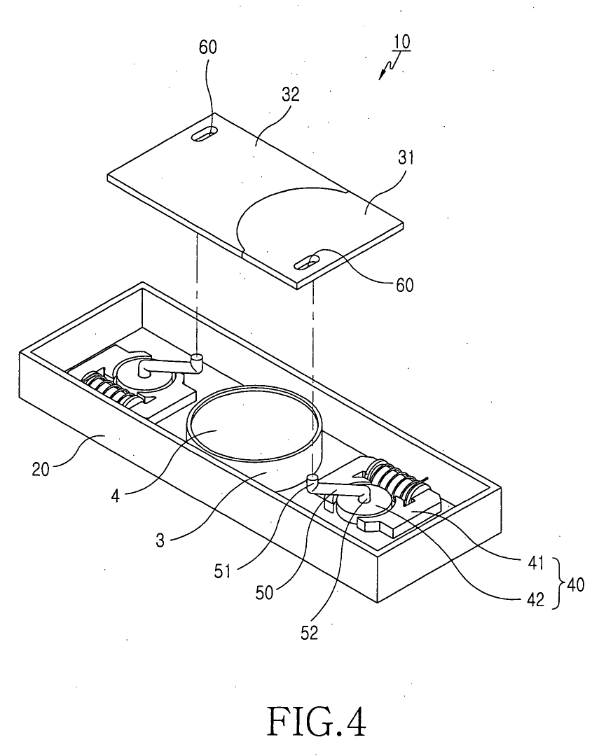

Referring to FIGS. 3 and 4, a shutter driving apparatus 10 for a camera module in accordance with a first embodiment of the present invention comprises a lens housing 20, a pair of shutter blades commonly represented by the reference numeral 30, and a pair of shutter driving sections 40. The lens housing 20 is configured to allow the shutter blades 30 to be slidingly moved therein. The shutter blades 30 are provided in the lens housing 20 so that they can be slidingly moved along the lengthwise direction of the lens housing to open and close a lens opening 4 of a lens module 3. The pair of shutter driving sections 40 are connected to the shutter blades 30 by respective rotation links 50 and are placed below the shutter blades 30. Each shutter driving section 40 has an electromagnet 41 and a permanent magnet 42 positioned between the poles of the electromagnet. The permanent magnet 42 is connected to the rotation link 50 and is rotated by a magnetic field, created as current is applied to the electromagnet 41, to slidingly move the shutter blade 30 associated therewith.

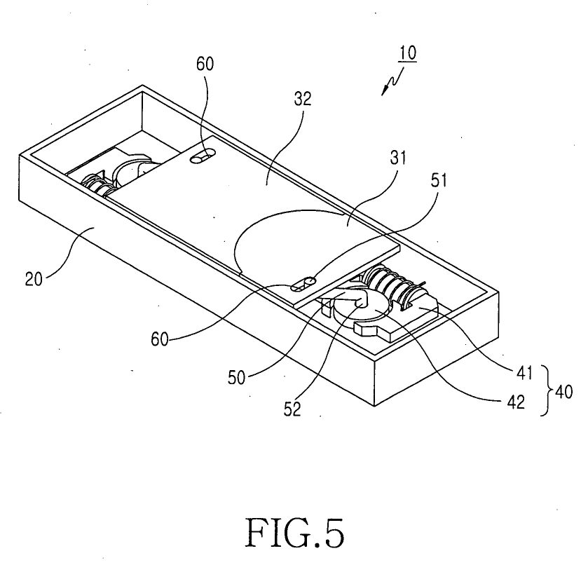

Referring to FIGS. 4 and 5, one end 51 of each rotation link 50 is connected to the shutter blade 30 to transmit the rotation force of the permanent magnet 42 to the shutter blade, and the other end 52 of the rotation link is connected to the permanent magnet 42. The shutter blade 30 and the permanent magnet 42 are defined with connection holes 60 for allowing the ends of the rotation link 50 to be fitted therein.

Referring to FIGS. 5, 6 and 9 and as seen horizontally along the axis of the lens opening 4 with the lengthwise direction of the lens housing 20 being horizontal, the shutter blades 30 can be slidingly moved in both leftward and rightward directions.

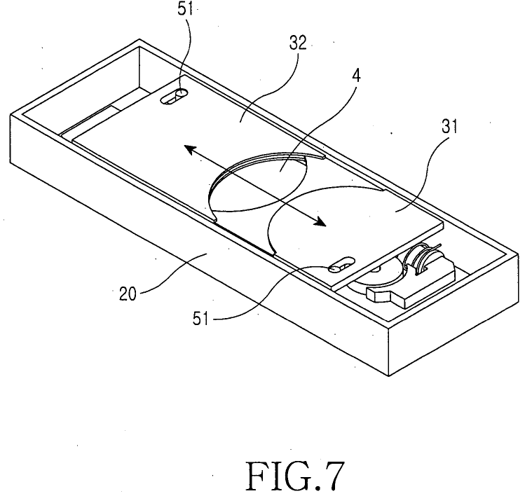

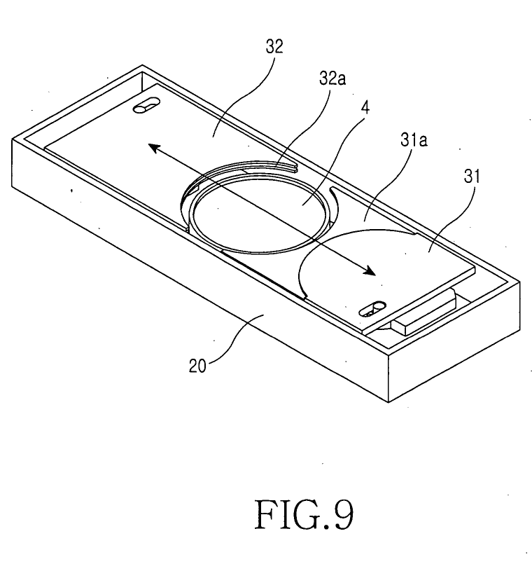

Referring to FIGS. 7 and 9, one shutter blade 31 is formed with an engagement portion 31a, and the other shutter blade 32 is defined with an engagement groove 32a. The engagement portion 31a can be engaged within or disengaged from, the engagement groove 32a when the shutter blades 30 are slidingly moved.

The engagement portion 31a and the engagement groove 32a have a semicircular profile.

Referring to FIGS. 3, 6, 8 and 10, each shutter driving section 40 comprises the electromagnet 41 and the permanent magnet 42. Each of the electromagnets 41 has a coil for creating a magnetic field, as current is applied to the coil. Each electromagnet 41, upon application of the current, has opposite north (N) and south (S) polarities to produce magnetic force. The electromagnet 41 has two ends that serve as poles of opposite polarity, the magnetic force existing in a direction from one of the poles to the other. The permanent magnet 42 is positioned between the pair of poles to thereby be rotated by the magnetic force.

Although the drawings show a single, integral electromagnet 41 with two opposite poles between which the permanent magnet 42 is disposed, it is within the intended scope of the invention that the two, opposite poles may belong correspondingly to separate electromagnets magnetized by the same or separate coils. The separate electromagnets could collectively consist of two electromagnets whose inner poles face each other and are disposed within the coil, for example.

A first preferred embodiment of the present invention provides each of the sections 40 being configured for creating a pair of electromagnetically-opposite electromagnetic poles. Each section 40 also has a permanent magnet connected to the rotation link 50 and positioned between the poles such that the permanent magnet 42 is rotated due to a magnetic field created as current is applied to an electromagnet, to slidingly move an associated shutter blade 31, 32.

Hereinafter, an operational procedure of the shutter driving apparatus for a camera module according to the first preferred embodiment of the present invention, constructed as mentioned above, is described in detail with reference to FIGS. 3 through 11.

Referring to FIGS. 3 and 4, the shutter driving apparatus 10 for a camera module includes the lens housing 20, the pair of shutter blades 31, 32, and the pair of shutter driving sections 40.

The pair of shutter driving sections 40 are provided in the lens housing 20 in the lengthwise direction of the lens housing, and the pair of shutter blades 30 are respectively disposed above the shutter driving sections 40.

Referring to FIG. 4, the pair of shutter blades 31, 32 are positioned above the lens opening 4 which is defined in the lens housing 20. At this time, as can be readily seen from FIG. 5, one end 51 of the rotation link 50 is rotatably fitted into the connection hole 60 which is defined in the shutter blade 30. The other end 52 of the rotation link 50 is fixedly fitted into the connection hole 60 which is defined in the permanent magnet 42 of the shutter driving section 40.

In this state, as shown in FIGS. 5, 7 and 9, when it is necessary to operate the pair of shutter blades 31, 32, current is applied to the electromagnet 41 which is located adjacent to the lens opening 4.

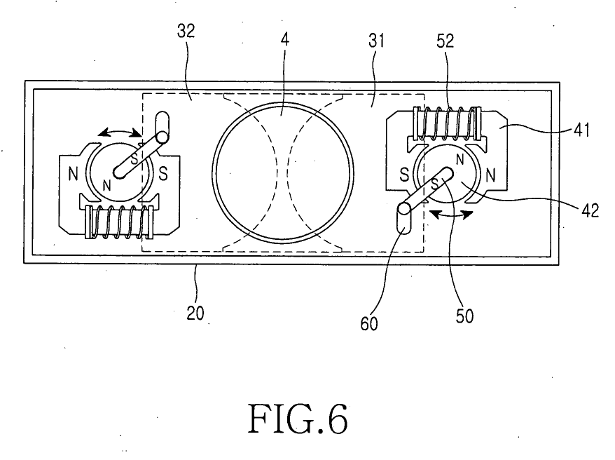

This magnetizes the electromagnet 41 into N and S polarities at respective poles to produce magnetic force, as seen in FIG. 6 for example.

As seen in the sequence of FIGS. 6, 8 and 10, the magnetic force rotates, in a counterclockwise direction, the permanent magnet 42 positioned between the pair of poles. Due to the fact that the permanent magnet 42 is securely connected to the rotation link 50, rotation of the permanent magnet integrally rotates the rotation link 50. At the same time, as seeable with the lens housing 20 disposed horizontally so that the axis of the lens opening 4 is in the line of sight, the pair of shutter blades 31, 32 are slidingly moved outwardly in both sideward directions.

As can be readily seen from FIGS. 7 and 9, at the same time the shutter blades 31, 32 are slidingly moved outwardly, the engagement portion 31a formed on one shutter blade 31 is disengaged from the engagement groove 32a defined in the other shutter blade 32.

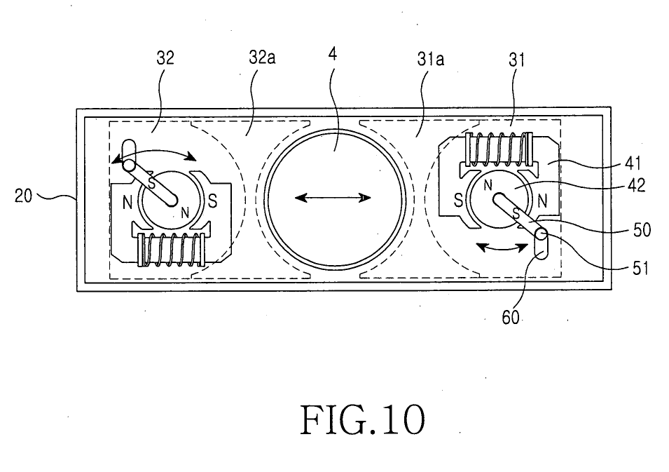

As shown in FIG. 10, as the shutter blades 31, 32 are slidingly moved outwardly in the sideward directions, the lens opening 4 is opened.

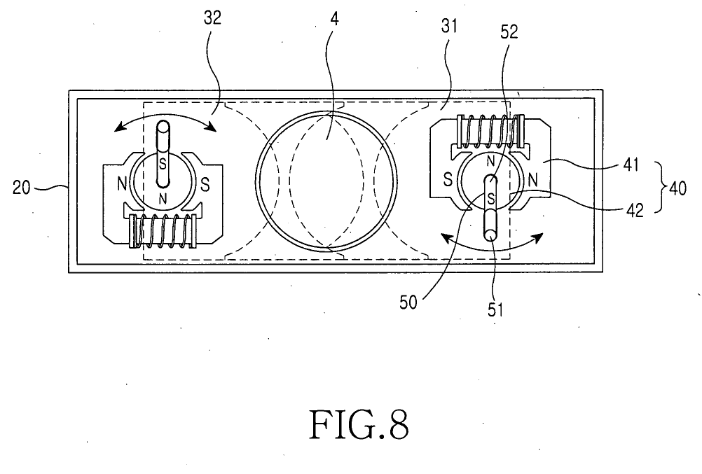

Then, as can be seen from FIGS. 7 and 8, current is applicable again to the electromagnet 41 in the reverse direction. By changing current direction, the S and N polarities of the electromagnet 41 are reversed (not shown) so that magnetic force is produced in the reverse direction. This likewise rotates the permanent magnet 42 in the reverse direction, i.e., clockwise direction. The rotation link 50 is correspondingly rotated in the reverse direction integrally with the permanent magnet 42. As a result, the pair of shutter blades 31, 32 are slidingly moved inwardly in the sideward directions to close the lens opening 4.

Referring to FIG. 4, at the same time the shutter blades 31, 32 are slidingly moved inwardly toward each other, the engagement portion 31a formed on the shutter blade 31 is engaged into the engagement groove 32a defined in the other shutter blade 32.

Here, as described above, the engagement portion 31a and engagement groove 32a of the shutter blades 31, 32 have a semicircular profile to ensure easy engagement.

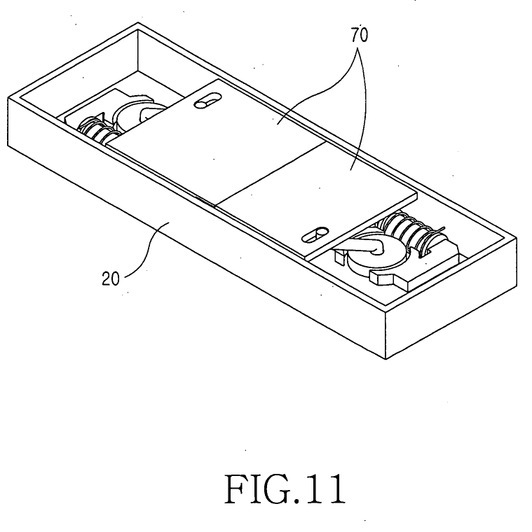

The shutter blades 30, according to a variation of the first embodiment of the present invention may alternatively, as shown in FIG. 11, have a square-shaped configuration.

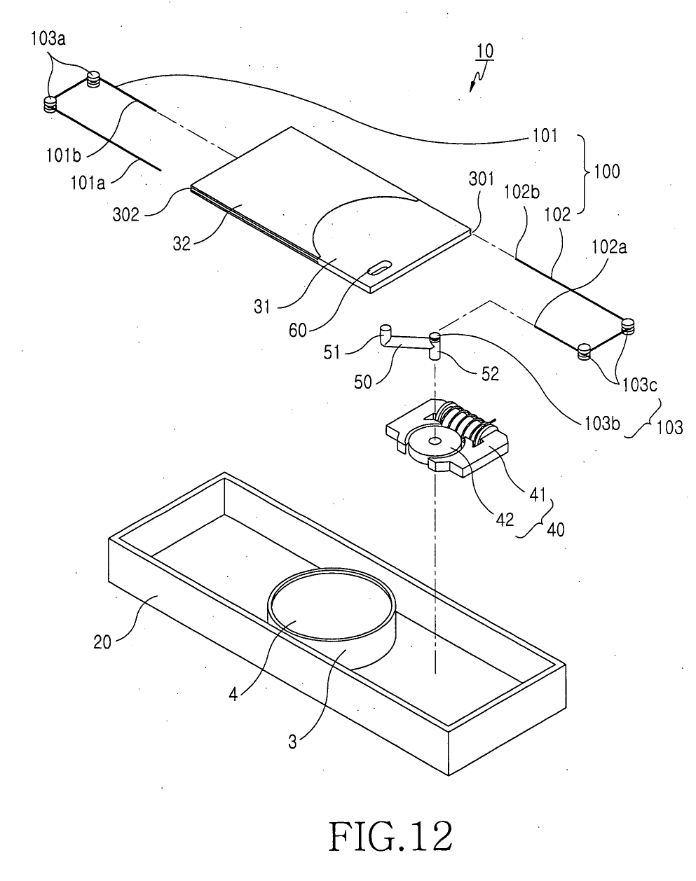

Hereinbelow, an operational procedure of the shutter driving apparatus for a camera module according to a second preferred embodiment of the present invention is described in detail with reference to FIGS. 12 through 19.

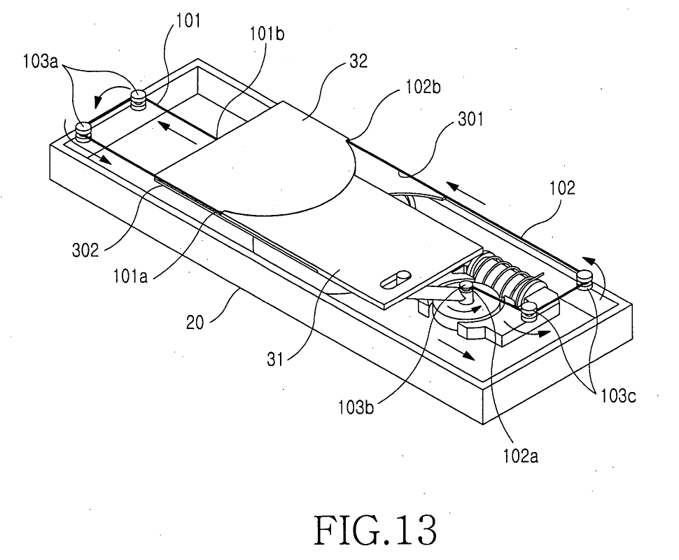

Referring to FIGS. 12 and 13, a shutter driving apparatus 10 for a camera module comprises a lens housing 20, first and second shutter blades 31, 32, a shutter driving section 40, and at least one wire winding means 100.

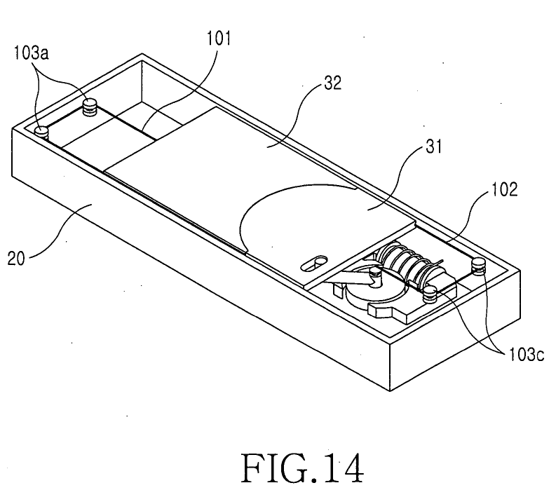

Referring to FIG. 14, the shutter driving section 40 is provided in the lens housing 20 in the lengthwise direction of the lens housing, and the first and second shutter blades 31, 32 are disposed above the shutter driving section 40. The first and second shutter blades 31, 32 are positioned above the lens opening 4 which is defined in the lens housing 20.

One end 51 of the rotation link 50 is rotatably fitted into the connection hole 60 which is defined in the first shutter blade 31, and the other end 52 of the rotation link 50 is fixedly fitted into the connection hole 60 which is defined in the permanent magnet 42 of the shutter driving section 40.

As shown in FIG. 13, the wire winding means 100 is composed of first and second wires 101, 102 and at least one roller part 103. In this preferred embodiment, the roller part 103 comprises first, second and third roller parts 103a, 103b, 103c. The first wire 101 has one end 101a which is connected to an end of the first shutter blade 31 and the other end 101b which is connected to a widthwise middle portion of the second shutter blade 32. The second wire 102 has one end 102a which is connected to the rotation link 50 and the other end 102b which is connected to an end of the second shutter blade 32.

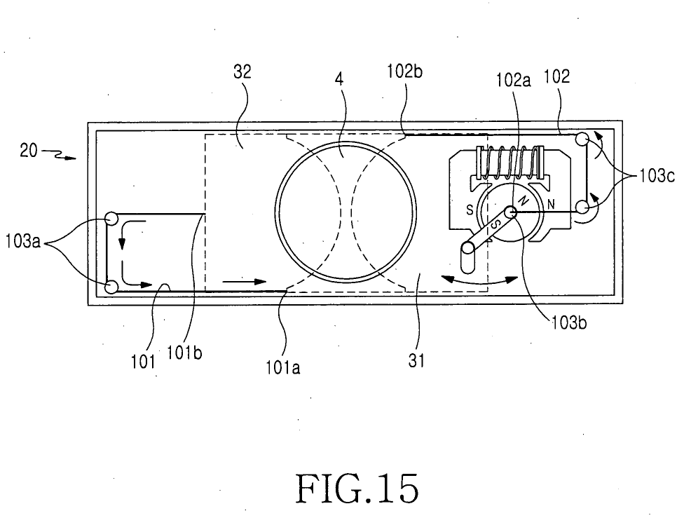

Referring to FIGS. 14, 16 and 18, when it is necessary to operate the first and second shutter blades 31, 32, current is applied to the electromagnet 41 which is located adjacent to the lens opening 4. This magnetizes the electromagnet 41 into N and S polarities to produce magnetic force. Due to the magnetic force, the permanent magnet 42 positioned between the pair of opposite poles rotates in a forward, i.e., counterclockwise, direction, as seen from the sequence of FIGS. 14, 16 and 18. FIGS. 15, 17 and 19 likewise show the counterclockwise rotation sequence.

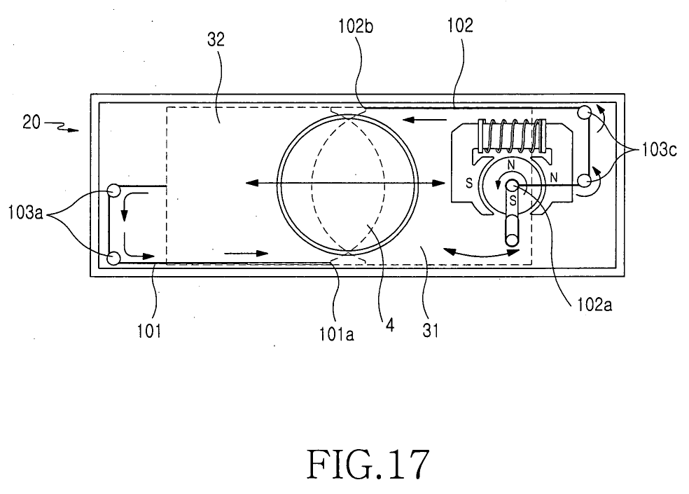

Referring to FIGS. 15 and 17, due to the fact that the permanent magnet 42 is securely connected to the rotation link 50, rotation of the permanent magnet integrally rotates the rotation link 50. At the same time, the first shutter blade 31 is slidingly moved in the lengthwise direction of the lens housing 20.

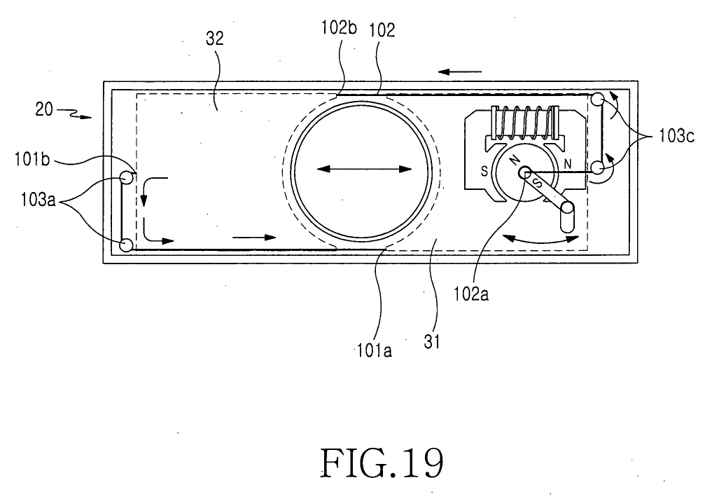

At this time, as shown in FIG. 19, one end 101a of the first wire 101 connected to the first shutter blade 31 is moved in the sliding direction of the first shutter blade 31. The first wire 101 is moved on the first roller parts 103a which are located adjacent to the second shutter blade 32. The first roller parts 103a change the sliding movement direction of the first wire 101 and slidingly move the second shutter blade 32 which is connected to the other end 101b of the first wire 101. At this time, one end 102a of the second wire 102 which is connected to the second roller part 103b of the rotation link 50 is rotated in the forward direction. By this fact, the second wire 102 which is wound on the second roller part 103b of the rotation link 50 is unwound from the second roller part.

Due to the fact that the other end 102b of the second wire 102 is connected to the second shutter blade 32, at the same time the second wire is unwound from the second roller part 103b, the other end 102b of the second wire is moved on the third roller parts 103c which are located adjacent to the first shutter blade 31.

Therefore, referring to FIGS. 17 and 19, as the second wire 102 is unwound from the second roller part 103b, the second shutter blade 32 can be slidingly moved.

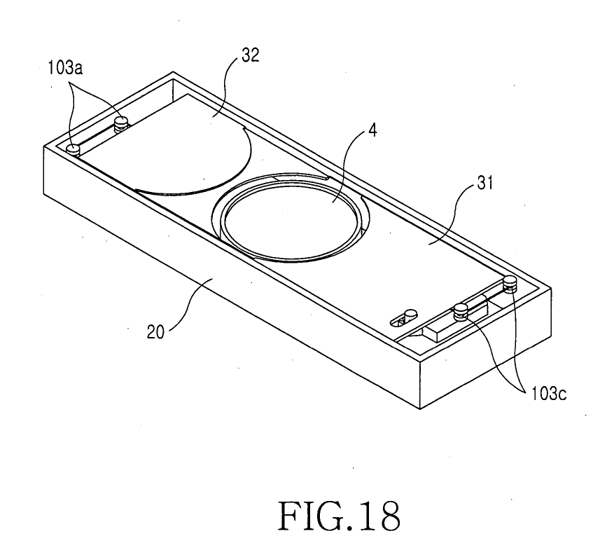

As a consequence, referring to FIG. 18, as the first and second shutter blades 31, 32 are slidingly moved, the lens opening 4 is opened.

At the same time the shutter blades 31, 32 are slidingly moved, the engagement portion 31a formed on the first shutter blade 31 is disengaged from the engagement groove 32a defined in the second shutter blade 32.

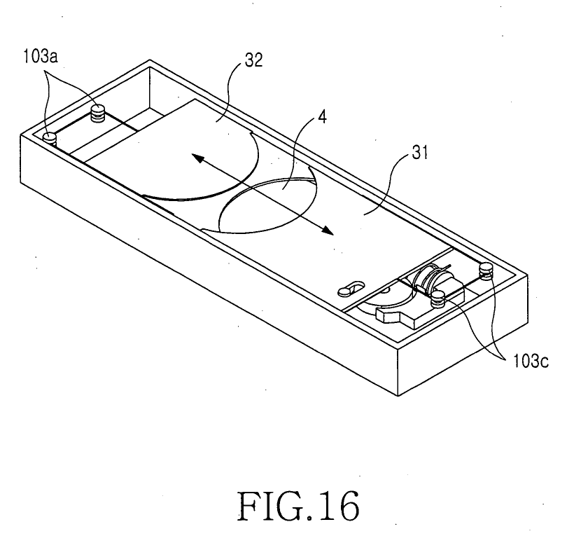

Then, as can be readily seen from FIGS. 16 and 17, current is again applicable to the electromagnet 41 in the reverse direction. By changing the direction of the current, the S and N polarities of the electromagnet 41 are reversed (not shown). The permanent magnet 42 is correspondingly rotates in the reverse, i.e., clockwise, direction.

By this action, as shown in FIG. 15, the rotation link 50 is also rotated clockwise integrally with the permanent magnet 42, and the first shutter blade 31 is slidingly moved inwardly.

Referring to FIG. 17, as the rotation link 50 is rotated, the rotation link 50 winds one end 102a of the second wire 102 on the second roller part 103b. The second wire 102 is correspondingly moved on the third roller parts 103c, and the second shutter blade 32 connected to the other end 102b of the second wire 102 is slidingly moved inwardly.

Referring to FIG. 14, as the first and second shutter blades 31, 32 are moved inwardly, the lens opening 4 is closed.

Referring to FIGS. 12 and 13, a first guide groove 301 for guiding movement of the second wire 102 is defined on an edge of the first shutter blade 31 to extend in the lengthwise direction of the first shutter blade. A second guide groove 302 for guiding movement of the first wire 101 is defined on an edge of the second shutter blade 32 to extend in the lengthwise direction of the second shutter blade. As shown in FIGS. 12 and 13, these two edges are preferably opposite.

As is apparent from the above descriptions, the shutter driving apparatus for a camera module according to the present invention provides advantages in that, since a pair of shutter driving sections are constructed to slidingly move shutter blades provided to a camera lens module in both sideward directions to thereby open and close a lens opening, a space required to install the shutter driving apparatus in the camera lens module can be reduced, thereby affording increased miniaturization and slimness of the camera module.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A shutter driving apparatus for a camera lens module, comprising:
a lens housing;
a pair of shutter blades provided to the lens housing to be slidingly moved in a lengthwise direction of the lens housing to thereby open and close a lens opening of the camera lens module; and
a pair of shutter driving sections respectively connected to the shutter blades via rotation links, each of said sections being configured for creating a pair of electromagnetically-opposite electromagnetic poles and having a permanent magnet connected to the rotation link and positioned between the poles such that the permanent magnet is rotated due to a magnetic field created as current is applied to an electromagnet, to slidingly move an associated shutter blade.

2. The apparatus of claim 1, wherein at least one of said poles is a pole of said electromagnet.

3. The apparatus of claim 2, wherein both of said poles are poles of said electromagnet.

4. The shutter driving apparatus as set forth in claim 1, wherein each of the rotation links has an end connected to the respective one of the pair of shutter blades and another end connected to the respective permanent magnet.

5. The shutter driving apparatus as set forth in claim 1, wherein each of the shutter blade and the permanent magnet is defined with a connection hole into which a corresponding end of the respective rotation link is fitted.

6. The shutter driving apparatus as set forth in claim 1, configured such that, in response to the rotation, the shutter blades are slidingly moved both leftward and rightward as seen horizontally along an axis of the lens opening with the lens housing disposed horizontally in the lengthwise direction.

7. The shutter driving apparatus as set forth in claim 1, wherein one of the shutter blades is formed with an engagement portion, and the other shutter blade is defined with an engagement groove so that the engagement portion is engageable with or disengageable from the engagement groove when the shutter blades are slidingly moved.

8. The apparatus of claim 7, wherein the engagement is engagement within the engagement groove.

9. The shutter driving apparatus as set forth in claim 7, wherein the engagement portion and the engagement groove have a semicircular profile.

10. The shutter driving apparatus as set forth in claim 1, wherein each of the shutter driving sections comprises a pair of electromagnets, of which said electromagnet is one, disposed adjacent to the lens opening, and a permanent magnet positioned between the electromagnets such that the electromagnets are magnetized into N and S polarities to produce magnetic force as current is applied to the electromagnets, and the permanent magnet is rotated by the magnetic force.

11. The shutter driving apparatus as set forth in claim 1, wherein each shutter blade has a square-shaped configuration.

12. A shutter driving apparatus for a camera lens module, comprising:
a lens housing;
first and second shutter blades provided to the lens housing to be slidingly moved in a lengthwise direction of the lens housing to thereby open and close a lens opening of the camera lens module;
a shutter driving section connected to the first shutter blade via a rotation link and being configured for creating a pair of electromagnetically-opposite electromagnet poles and having a permanent magnet connected to the rotation link and positioned between the poles such that the permanent magnet is rotated due to a magnetic field created as current is applied to an electromagnet, to slidingly move the shutter blades; and
at least one wire winding means for, when the shutter driving section is operated, winding and unwinding wires which respectively connect the first and second shutter blades to the shutter driving section and for thereby slidingly moving the shutter blades.

13. The apparatus of claim 12, wherein at least one of said poles is a pole of said electromagnet.

14. The apparatus of claim 13, wherein both of said poles are poles of said electromagnet.

15. The shutter driving apparatus as set forth in claim 12, wherein the shutter driving section is installed below the first shutter blade, and configured so that the sliding movement moves the second shutter blade simultaneously with the first shutter blade.

16. The shutter driving apparatus as set forth in claim 12, wherein the wire winding means comprises:
a first wire connecting the first and second shutter blades with each other;
a second wire connecting the second shutter blade and the rotation link with each other; and
at least one roller part arranged in the lens housing such that the first shutter blade is slidingly moved when the permanent magnet and the rotation link of the shutter driving section are integrally rotated in counterclockwise and clockwise directions, and the second shutter blade is slidingly moved when the first and second wires are wound and unwound on the roller part.

17. The shutter driving apparatus as set forth in claim 16, wherein the roller part comprises:
a first roller part arranged adjacent to the second shutter blade so that the first wire is movable in both directions on the first roller part to slidingly move the second shutter blade when the first shutter blade is slidingly moved;
a second roller part provided to the rotation link to wind and unwind the second wire thereon and therefrom when the second shutter blade is slidingly moved; and
a third roller part arranged adjacent to the first shutter blade so that the second wire is movable in both directions on the third roller part to allow sliding movement of the second shutter blade.

18. The shutter driving apparatus as set forth in claim 16, wherein the first wire has an end which is connected to an end of the first shutter blade and another end which is connected to a widthwise middle portion of the second shutter blade, and the second wire has an end which is connected to the rotation link and another end which is connected to an end of the second shutter blade.

19. The shutter driving apparatus as set forth in claim 12, wherein a first guide groove for guiding movement of the second wire is defined on an edge of the first shutter blade to extend in a lengthwise direction of the first shutter blade, and a second guide groove for guiding movement of the first wire is defined on an edge of the second shutter blade to extend in a lengthwise direction of the second shutter blade.

20. A shutter driving apparatus for a camera lens module, comprising:
a lens housing;
a shutter blade provided to the lens housing to be slidingly moved in a lengthwise direction of the lens housing to thereby open and close a lens opening of the camera lens module; and
a shutter driving section connected to the shutter blade via a rotation link and configured for creating a pair of electromagnetically-opposite electromagnetic poles and having a permanent magnet such that the rotation link is rotated due to a magnetic field created as current is applied to an electromagnet having at least one of said poles, to slidingly move the shutter blade.
